(19) United States
(12) Patent Application Publication
(10) Pub. No.: US 2013/0301618 A1
(43) Pub. Date: Nov. 14, 2013

(54) RADIO COMMUNICATION SYSTEM AND RADIO STATION

(71) Applicant: HITACHI, LTD., Tokyo (JP)

(72) Inventors: Satoshi Tamaki, Yokohama (JP); Yusuke Shomura, Hiratsuka (JP); Eriko Takeda, Tokyo (JP)

(73) Assignee: Hitachi, Ltd., Tokyo (JP)

(21) Appl. No.: 13/888,489

(22) Filed: May 7, 2013

(30) Foreign Application Priority Data
May 11, 2012 (JP) 2012-109383

(51) Int. Cl. H04W 72/04

(52) U.S. Cl. CPC H04W 72/04
USPC 370/335

(57) ABSTRACT

Radio communication system and radio station which enable efficient use of radio resources while coping with a sudden change in radio communication quality are to be provided. Radio communication system includes plural radio stations. At least one of the plural radio stations allocates a part of an allocatable communication resource as one or more individual resources in which a source radio station and a destination radio station are individually set, and allocates another part of the allocatable communication resource as one or more shared resources which are used in common by plural source radio stations or plural destination radio stations. Each of the radio stations encodes a transmission signal using a systematic code, sends the transmission signal before being encoded, using the individual resource allocated to each of the radio stations, and sends a parity portion of the encoded transmission signal, using the shared resource allocated.

### BACKGROUND OF THE INVENTION

1. Field of the Invention

The present invention relates to a radio communication system and a radio station, and particularly to a radio communication system in which a specific coordination device allocates radio resources so that packet communication is carried out between plural radio stations, and a radio station in this radio communication system.

2. Description of the Related Art

Radio packet communication via a wireless LAN (local area network) or wireless PAN (personal area network) is used for various purposes because of its ability to enable easy communication with a moving apparatus and its inexpensive installation cost. Meanwhile, since preparation of plural communication media and separation of these communication media as in wired communication cannot be realized in wireless communication, communications made at the same frequency and the same time collide with each other. Therefore, a certain coordination means to avoid such collision of communications is necessary in order to realize stable communication.

For example, radio packet communication via a wireless LAN or wireless PAN uses a mechanism such as carrier sense in which a signal is sent after it is confirmed that a signal from another device cannot be received, in order to avoid collision of packets. Alternatively, for example, a coordination device called coordinator is used and the coordinator allocates frequency channels or time slots in such a way that no collision of packets occurs.

For example, according to the radio IEEE 802.15.4 standard, which is a normal standard for wireless PAN, a contention access period and a contention-free period are prepared. During the contention access period, each communication device conducts carrier sense and carries out communication of non-stationary messages or the like. During the contention-free period, the coordinator allocates time slots and communication of stationary data or the like is carried out.

Based on such a standard technique, various techniques to realize high-quality communication that is fit for purpose are proposed. For example, JP-A-2004-40645 discloses a technique in which contention-free periods in plural networks are controlled so as not to collide with each other.

Generally, wireless communication is characterized by greater changes in propagation environment and more unstable communication quality than in wired communication. In a wireless communication network having plural wireless communication sections, if information about changes in the propagation environment of each wireless communication section is gathered in one place and resource allocation and the like is controlled, radio resources can be used efficiently. However, the costs of information gathering and control are high and there is also a problem that a large control delay makes it difficult to cope with a sudden change. Meanwhile, if resource allocation or the like is controlled separately at each position within the wireless communication network, a sudden change can be coped with at a lower cost. However, there is a problem that efficiency of the wileress communication network is lowered as a whole.

### SUMMARY OF THE INVENTION

In order to solve the foregoing problems, an object of the invention is to provide a radio communication system and a radio station which enable efficient use of radio resources while coping with a sudden change in radio communication quality.

A representative example of the invention can be configured as follows. That is, in a radio communication system including plural radio stations, at least one of the plural radio stations has a communication resource allocation function. The radio station with communication resource allocation function allocates a part of an allocatable communication resource as one or more dedicated resources in which a source radio station and a destination radio station are individually set, and allocates another part of the allocatable communication resource as one or more shared resources which are used in common by plural source radio stations or plural destination radio stations. Each of the radio stations encodes a transmission signal using a systematic code, sends the transmission signal before being encoded, using the dedicated resource allocated to each of the radio stations, and sends a parity portion of the encoded transmission signal, using the shared resource allocated to each of the radio stations.

According to an embodiment of the invention, a radio communication system and a radio station which enable efficient use of radio resources while coping with a sudden change in radio communication quality can be provided.

### BRIEF DESCRIPTION OF THE DRAWINGS

FIG. 1 is an explanatory view showing an example of a radio communication system configuration according to an embodiment of the invention.

FIG. 2 shows an example of the functional configuration of a radio station according to an embodiment of the invention.

FIGS. 3A to 3D are explanatory views showing an example of an Ack signal according to an embodiment of the invention.

FIG. 4 is a schematic view showing resource allocation according to an embodiment of the invention.

FIG. 5 is a schematic view showing network coordination according to an embodiment of the invention.

FIG. 6 is a block diagram schematically showing the hardware configuration of a radio station including a DSP and a CPU as principal components according to an embodiment of the invention.

### DESCRIPTION OF EMBODIMENTS

Hereinafter, various embodiments of the invention will be described with reference to the drawings. The number of radio stations and the connection between radio stations in the following description and the drawings are only examples. The number of radio stations in a radio communication system to which the invention is applied may be different from the following examples. Also, the connection between radio stations, such as which radio station communicates with which radio station, may be different from the following examples.

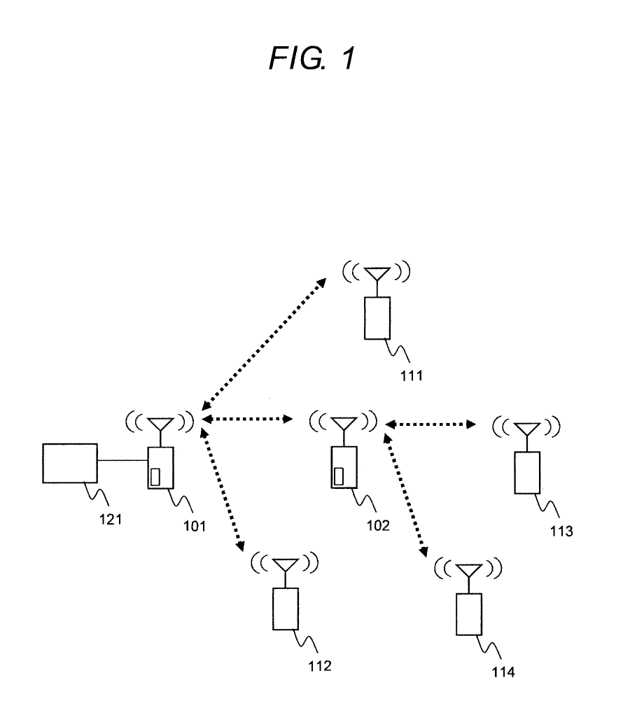

FIG. 1 is an explanatory view showing an example of a radio communication system configuration according to an embodiment of the invention. The radio communication system according to this embodiment includes a network coordinator 121, one or plural radio stations with resource allocation function, and one or plural radio stations without resource allocation function. In the radio communication system of this embodiment, radio communication is carried out between a radio station with resource allocation function and a radio station without resource allocation function, or between a radio station with resource allocation function and another radio station with resource allocation function. In the example of FIG. 1, a radio station 101 and a radio station 102 are radio stations with resource allocation function, and radio stations 111 to 114 are radio stations without resource allocation function. In the example of FIG. 1, the network coordinator 121 and the radio station 101 are shown separately. However, if the radio station 101 has a network coordination function, the separate network coordinator 121 is not necessary. In such a case, the radio station 101 also acts as a network coordinator.

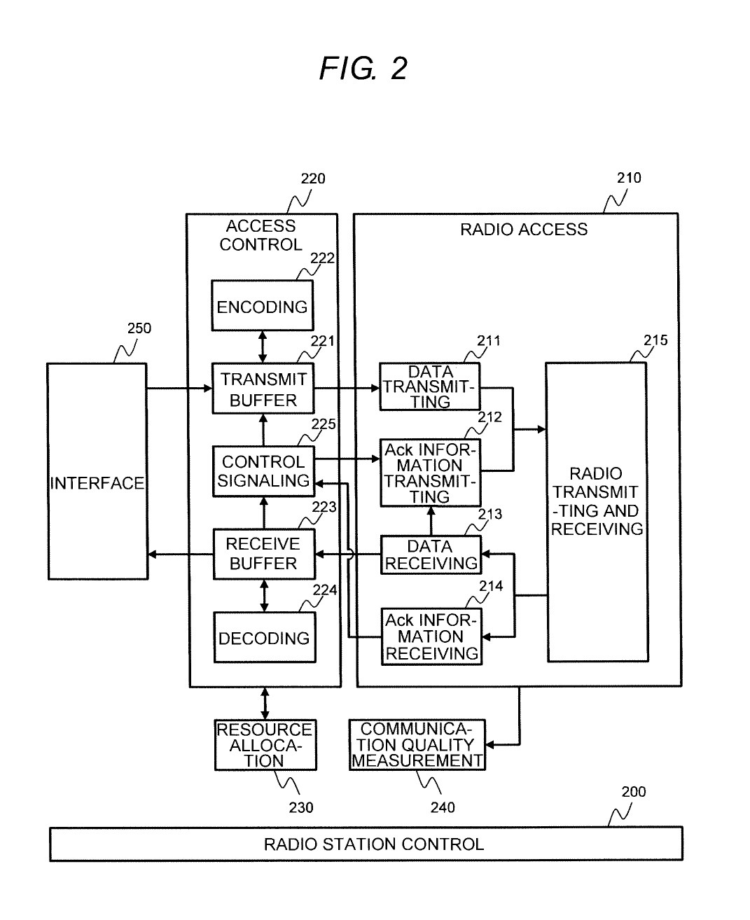

FIG. 2 shows an example of the functional configuration of a radio station according to an embodiment of the invention.

The radio station of the invention shown in FIG. 2 includes a radio station control block 200, a radio access block 210, an access control block 220, a resource allocation block 230, a communication quality measurement block 240, and an interface block 250. The example of FIG. 2 is an example of the functional configuration of a radio station with resource allocation function (for example, the radio station 101 and the radio station 102 of FIG. 1). A radio station without resource allocation function (for example, the radio stations 111 to 114 of FIG. 1) includes the radio station control block 200, the radio access block 210, the access control block 220, the communication quality measurement block 240, and the interface block 250, without having the resource allocation block 230.

The radio station control block 200 sends and receives messages between radio stations, controls the operation of the entire radio station, and holds information related to the operation of the entire radio station.

The radio station control block 200, for example, notifies the radio access block 210 of information related to signal transmission, such as whether there is a signal transmission or not, signal transmission time, modulation system, and transmission power. The radio station control block 200 also notifies the radio access block 210 of information related to signal reception, such as whether there is a signal reception or not, signal reception time, and modulation system. Moreover, the radio station control block 200 notifies the radio access block 210 of parameter information for obtaining reception quality information such as averaging method.

The radio station control block 200 requests the resource allocation function and the network coordinator 121 to provide a resource, in accordance with the volume of communication and communication quality measured by the communication quality measurement block 240. If the radio station control block 200 requests a resource used for communication with a radio station that is farther from the network coordinator 121 than the own station is, the radio station control block 200 notifies the resource allocation block 230 within the own station of the resource request, and sends a resource request message to the network coordinator 121. If the radio station control block 200 requests a resource used for communication with a radio station that is closer to the network coordinator 121 than the own station is, the radio station control block 200 sends a resource request message to a radio station that is closer to the network coordinator 121 than the own station is and that directly communicates with the own station, and to the network coordinator 121. If the own station receives a resource request message, the radio station control block 200 notifies the resource allocation block 230 within the own station of the resource request. If the own station receives a resource range allocation message, the radio station control block 200 notifies the resource allocation block 230 of the resource range allocation.

A resource request message includes information indicating the amount of resources required such as volume of communication data and communication speed, and may include information indicating communication quality such as estimated error rate.

The radio access block 210 includes a data transmitting block 211, an Ack information transmitting block 212, a data receiving block 213, an Ack information receiving block 214, and a radio transmitting and receiving block 215, and carries out radio communication with a counterpart radio station.

The data transmitting block 211 creates a transmission signal based on transmission data received from the access control block 220 and sends the transmission signal to the radio transmitting and receiving block 215. To create the transmission signal, the information related to signal transmission such as signal transmission time, modulation system, and transmission power received from the radio station control block 200 is used, and processing such as modulation, adjustment of signal amplitude corresponding to the transmission power, error correction coding, addition of an error detection code, change to frequency, and diffusion, is carried out partly or entirely according to need.

The Ack information transmitting block 212 generates an Ack transmission signal based on the information about whether there is a signal reception or not, received from the data receiving block 213 and the access control block 220, and sends the Ack transmission signal to the radio transmitting and receiving block 215. To create the Ack transmission signal, the information related to signal transmission received from the radio station control block 200 is used.

The radio transmitting and receiving block 215 converts the frequency of the transmission signal and the Ack transmission signal received from the data transmitting block 211 and the Ack information transmitting block 212, thus converts these signals into radio frequency transmission signals, and sends these signals via an antenna. The radio transmitting and receiving block 215 also converts the frequency of a radio frequency reception signal received via the antenna, thus generates a reception signal and an Ack reception signal, and sends these signals to the data receiving block 213 and the Ack information receiving block 214.

The data receiving block 213 carries out reception processing of the reception signal received from the radio transmitting and receiving block 215 and sends the result of the reception processing to the access control block 220 as reception data. In the reception processing, the information related to signal reception such as signal reception time and modulation system received from the radio station control block 200 is used, and processing such as demodulation, decoding of the error correction code, confirmation of the error detection code, and inverse diffusion is carried out partly or entirely according to need. The data receiving block 213 also determines whether or not there is an error in the reception data acquired as a result of the reception processing, and sends the result of the determination to the access control block 220 and the Ack information transmitting block 212 together with index information indicating the data. To determine whether there is an error in the reception data or not, an error detection code, for example, CRC (cyclic redundancy check), or signal reception power or the like is used. The index information is, for example, one of the sequence number of the signal in question, the reception time of the signal in question, the transmission time of the signal in question, the source radio station ID of the signal in question and the like, or a combination of these.

The Ack information receiving block 214 carries out reception processing of the Ack reception signal received from the radio transmitting and receiving block 215 and sends information of the presence or absence of an error, and index information such as sequence number, obtained as a result of the reception processing, to the access control block 220 as reception Ack data. In the reception processing, the information related to signal reception received from the radio station control block 200 is used.

The radio access block 210 also creates reception quality information based on information such as the reception signal power of the signal received by the radio transmitting and receiving block 215, noise power, and the presence or absence of an error as a result of the reception processing by the data receiving block 213, and sends the reception quality information to the communication quality measurement block 240. When creating the reception quality information, the radio access block 210 carries out averaging processing or the like in accordance with the parameter information sent from the radio station control block 200. The reception quality information thus created is used, for example, as information indicating the communication quality of the radio station when generating a resource request message, and is used when the network coordinator 121 decides a range of resource allocation, as described later.

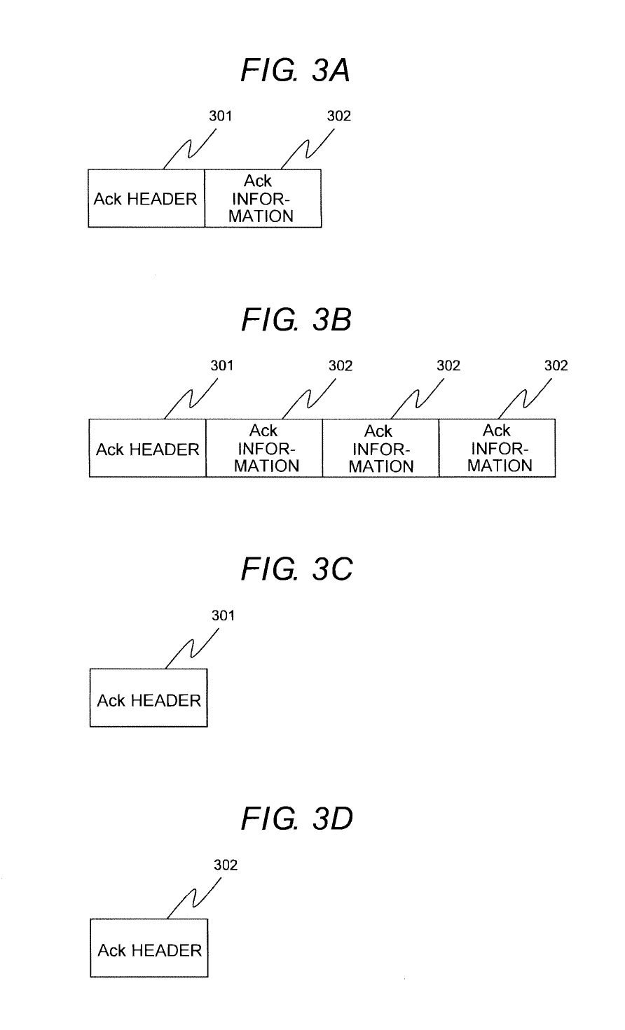

FIGS. 3A to 3D are explanatory views showing an example of an Ack signal according to an embodiment of the invention.

In the above description of the radio station shown in FIG. 2, an Ack signal transmitted from the radio station is referred to an Ack transmission signal, and an Ack signal received by the radio station is referred to as an Ack reception signal.

An Ack signal includes an Ack header 301 and Ack information 302, for example, as shown in FIG. 3A. The Ack header 301 is index information indicating data to which the Ack signal corresponds. The index information is, for example, one of the sequence number, the transmission signal of the signal, the source radio station ID of the signal, and the destination radio station ID of the signal or the like, or a combination of these. The Ack information 302 is a code (Ack) indicating that there are no errors in the corresponding signal or a code (Hack) indicating that there is an error in the corresponding signal.

The Ack signal may also includes a group of plural pieces of Ack information 302, for example, as shown in FIG. 3B. In this example, since three pieces of Ack information 302 are grouped, the Ack header 301 includes index information corresponding to each of the three pieces of Ack information 302. Also, for example, in the case where the Ack signal is sent only if the absence of errors is indicated, whereas the Ack signal is not sent if there is an error, or conversely, in the case where the transmission of the Ack signal itself indicates the presence or absence of an error, the Ack signal may include the Ack header 301 only, as shown in FIG. 3C. For example, in the case where the Ack signal is sent only if the absence of errors is indicated, it is determined that there is an error if the Ack signal is not successfully received within a predetermined time range. Also, for example, in the case where a data signal and the Ack signal are associated with each other based on time, as in the case where the Ack signal is sent after a predetermined time from the reception of a data signal, the Ack signal may include the Ack information 302 only, as shown in FIG. 3D.

The access control block 220 includes a transmit buffer block 221, an encoding block 222, a receive buffer block 223, a decoding block 224, and a control signaling block 225. The access control block 220 converts transmission information received from the interface block 250 into transmission data and delivers the transmission data to the radio access block 210. The access control block 220 also converts reception data received from the radio access block 210 into reception information and delivers the reception information to the interface block 250.

The transmit buffer block 221 accumulates the transmission information received from the interface block 250. The transmit buffer block 221 also sends the accumulated transmission information to the encoding block 222 and accumulates transmission parity information received from the encoding block 222. The transmit buffer block 221 also accumulates Ack control information received from the control signaling block 225. The transmit buffer block 221 also sends the accumulated transmission information, transmission parity information and Ack control information to the radio access block 210 by each unit of transmission.

The encoding block 222 carries out encoding processing of the transmission information received from the transmit buffer block 221, using an error correction code, and sends transmission parity information generated by the encoding processing to the transmit buffer block 221. As the error correction code, a code that has a characteristic of systematic code that data before encoding is included in data after encoding, for example, a Reed-Solomon code or the like is used.

The receive buffer block 223 accumulates the reception data received from the radio access block 210 and information about the presence or absence of errors in the reception data, and sends the reception data that is determined as not having errors to the interface block 250 as reception information. Also, if transmission parity information is included in the reception data received from the radio access block 210, the receive buffer block 223 extracts reception data corresponding to each identical codeword from the accumulated reception data, then collectively sends the extracted reception data to the decoding block 224, and accumulates the result of decoding and the information about the presence or absence of errors received from the decoding block 224, as reception data again. Also, if Ack control information is included in the reception data received from the radio access block 210, the receive buffer block 223 sends the Ack control information to the control signaling block 225. The receive buffer block 223 also sends the information about the presence or absence of errors received from the decoding block 224, to the control signaling block 225.

The decoding block 224 carries out decoding processing of the error correction code with respect to the reception data received from the receive buffer block 223 and sends the result of decoding and the information about the presence or absence of errors, obtained as a result of the decoding, to the receive buffer block 223. The decoding by the decoding block 224 uses the error correction code that is used when the signal is transmitted.

The control signaling block 225 notifies the transmit buffer block 221 so that the transmit buffer block 221 should send corresponding transmission parity information if there is an error, based on the reception Ack data received from the radio access block 210 and the Ack control information received from the receive buffer block 223. The control signaling block 225 creates Ack control in formation based on the information about the presence or absence of errors received from the receive buffer block 223 and sends the Ack control information to the transmit buffer block 221. The control signaling block 225 may also instruct the Ack information transmitting block 212 of the radio access block 210 to transmit the Ack signal, instead of creating Ack control information and sending the Ack control information to the transmit buffer block 221. The Ack control information is similar to the Ack signal shown in FIGS. 3A to 3D in terms of the information included therein, except that the Ack control information is treated as transmission data in the radio access block 210.

The resource allocation block 230 allocates resources to individual communications according to a resource range allocation notification and a resource request notification sent from the radio station control block 200.

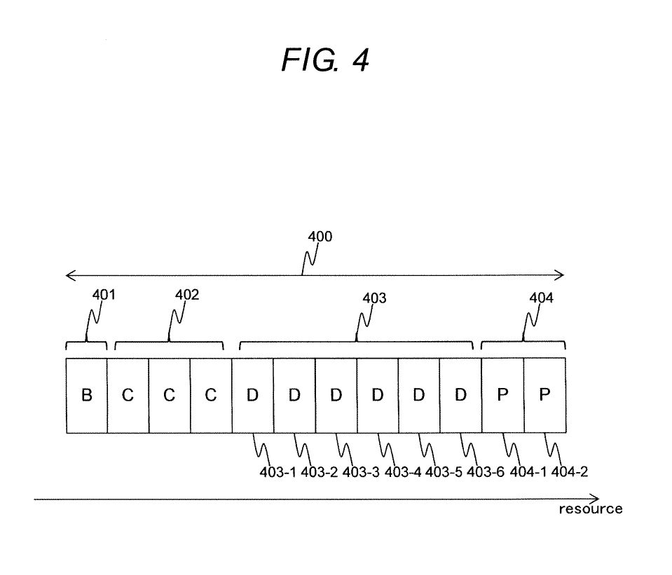

FIG. 4 is a schematic view showing resource allocation according to an embodiment of the invention.

A range of resource allocation 400 is a resource range designated by the resource range allocation notification. The resource allocation block 230 allocates the resource inside this range to individual communications. In the example of FIG. 4, the resource allocation block 230 divides the resource into four types, that is, a resource for broadcast signal 401, a resource for control signal 402, a resource reserved for dedicated signal 403, and a resource reserved for parity signal 404, and allocates these resources.

The resource for broadcast signal 401 is a resource for sending a broadcast signal from a radio station with resource allocation function. The broadcast signal includes, for example, a preamble for synchronization, the ID of the radio station transmitting the broadcast signal, an offset from base timing designated by the resource allocation notification, and the like. The broadcast signal may also include the result of the resource allocation carried out by the resource allocation block 230.

The resource for control signal 402 is a resource used for communication of a resource request message and a resource range allocation message between radio stations. Alternatively, the resource for control signal 402 may be used to notify each radio station of the resource allocation carried out by the resource allocation block 230.

The resource reserved for dedicated signal 403 is a resource used for transmission of transmission information and is allocated individually to each communication. For example, the resource allocation block 230 of the radio station 102 with resource allocation function of FIG. 1 allocates, for example, a resource 403-1 to the communication from the radio station 102 to the radio station 113, a resource 403-2 and a resource 403-3 to the communication from the radio station 102 to the radio station 114, a resource 403-4 to the communication from the radio station 113 to the radio station 102, and a resource 403-5 and a resource 403-6 to the communication from the radio station 114 to the radio station 102. In this manner, individual resources are allocated to each communication.

The resource reserved for parity signal 404 is a resource used for transmission of transmission parity information. In this embodiment, for example, if there is an error in the reception data, as described above, parity information is sent. Unlike the resource reserved for dedicated signal 403, the same resource reserved for parity signal 404 may be allocated to plural communications. The resource reserved for parity signal 404 can be allocated, for example, in such a way that a resource 404-1 is allocated to the communication from the radio station 102 to the radio station 113 and the communication from the radio station 102 to the radio station 114, whereas a resource 404-2 is allocated to the communication from the radio station 113 to the radio station 102 and the communication from the radio station 114 to the radio station 102. That is, the resource reserved for parity signal 404 is a resource shared by plural source radio stations or plural destination radio stations.

Since a resource for parity transmission no longer needs to be prepared for each communication, the utilization efficiency of the resource is improved. Also, since the probability that plural communications err simultaneously and require a resource reserved for parity signal simultaneously is low, described above, changes in radio communication quality can be coped with sufficiently.

If an error occurs only in one of plural communications (for example, the communication from the radio station 102 to the radio station 113 and the communication from the radio station 102 to the radio station 114) to which one resource reserved for parity signal 404 (for example, the resource reserved for parity signal 404-1) is allocated, the one resource reserved for parity signal 404 can be used to transmit a parity corresponding to the one communication that errs. Meanwhile, if plural communications err simultaneously, a parity corresponding to one of these communications alone may be transmitted using the one resource reserved for parity signal 404, or plural parities corresponding to these plural communications may be multiplexed with time, frequency, or a code or the like, and then transmitted using the one resource reserved for parity signal 404.

FIG. 4 shows an example of resource allocation in the case where a systematic code such as a Reed-Solomon code is used. However, resource allocation similar to the above can also be carried out in the case where another error correction code than the systematic code is used, and in the case where no error correction code is used. In such cases, the resource reserved for parity signal 404 (that is, shared resource) is also used for transmission of other data than the parity. For example, the control signaling block 225 may determine whether there is an error or not, based on the reception Ack data received from the radio access block 210 and the Ack control information received from the receive buffer block 223, and if there is an error in a part of the data transmitted using the resource reserved for dedicated signal 403, the control signaling block 225 may notify the transmit buffer block 221 that the transmit buffer block 221 should re-transmit data that is determined as having an error, using the resource reserved for parity signal 404. Alternatively, the control signaling block 225 may notify the transmit buffer block 221 that transmit buffer block 221 should re-transmit only the part of the data that is determined as having an error, using the resource reserved for parity signal 404. Also, the control signaling block 225 may notify the transmit buffer block 221 that the transmit buffer block 221 should transmit the same part of the same code of the data determined as having an error, or a different part thereof, using the resource reserved for parity signal 404.

The communication quality measurement block 240 accumulates the reception quality information received from the radio access block 210 and notifies the radio station control block 200 of the reception quality information as communication quality.

The interface block 250 carries out connection between the radio communication function and another network or device, and data transfer within the radio communication function.

When the reception information is received from the access control block 220, the interface block 250 decides the destination of the information in accordance with the destination address of the information. If the information is addressed to a radio station that is different from the own station on the same radio network, the interface block 250 sends the information to the access control block 220. If the information is a controlled message addressed to the own station, the interface block 250 sends the control message to the radio station control block 200. If the information is addressed to a communication station on another network, the interface block 250 sends the information to the interface of the corresponding network. If the information is addressed to another device within the own station, the interface block 250 sends the information to that device.

When information is received from another network or device, the interface block 250 adds destination address information or the like to the received information and then sends the information to the access control block 220 as transmission information. When a control message is received from the radio station control block 200, the interface block 250 adds destination address information or the like to the received control message and then sends the control message to the access control block 220 as transmission information.

The network coordinator 121 carries out network coordination in accordance with a resource request message sent from each radio station. In order to carry out network coordination, the network coordinator 121 sends a resource range allocation message to each radio station with resource allocation function.

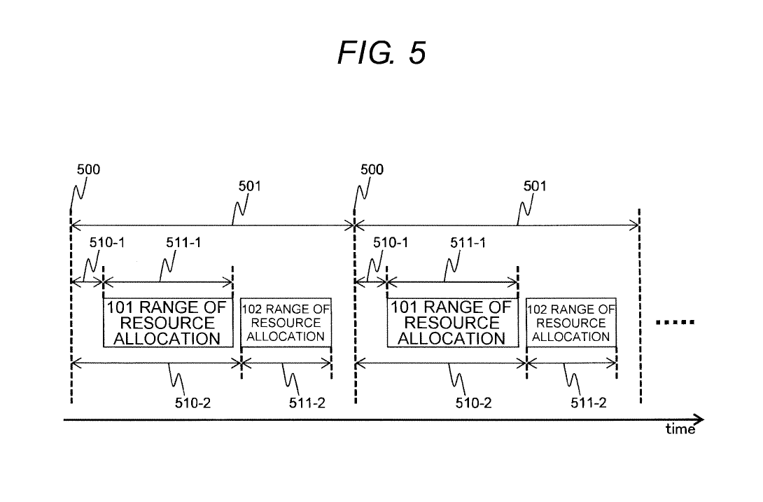

FIG. 5 is a schematic view showing network coordination according to an embodiment of the invention.

In the example shown in the schematic view of FIG. 5, network coordination is carried out by setting an overall resource allocation period and an offset and duration of each range of resource allocation. In FIG. 5, the horizontal direction expresses time. A time point 500 is base timing of resource allocation. A time period 501 is a resource allocation period. The network coordinator 121 notifies each radio station with resource allocation function, of a resource range allocation message including an individual resource allocation offset 510 of each radio station with resource allocation function (in the example of FIG. 5, offsets 510-1 and 510-2) and a range of resource allocation 511 (in the example of FIG. 5, ranges of resource allocation 511-1 and 511-2) in addition to the base timing of resource allocation 500 and the resource allocation period 501. In the case of the radio communication system of FIG. 1, since the radio station 101 and the radio station 102 are radio stations with resource allocation function, the resource allocation offset 510-1 for the radio station 101, the range of resource allocation 511-1 for the radio station 101, the resource allocation offset 510-2 for the radio station 102, and the range of resource allocation 511-2 for the radio station 102 are decided in such a way that the ranges of resource allocation for the radio station 101 and the radio station 102 do not overlap each other, as shown in FIG. 5.

When carrying out network coordination, the network coordinator 121 coordinates the network in such a way that a greater range is allocated as the traffic allocated by each resource allocation function becomes greater, in accordance with the resource request message transmitted from each communication station. For example, in the case of the example of FIG. 1, if the traffic allocated by the resource allocation function of the radio station 101 is greater than the traffic allocated by the resource allocation function of the radio station 102, network coordination is carried out in such a way that the range of resource allocation for the radio station 101 becomes greater than the range of resource allocation for the radio station 102.

Also, the network coordinator 121 may consider communication quality when carrying out network coordination so that each resource allocation function can allocate a resource reserved for parity signal corresponding to communication quality. For example, a quality coefficient that has a smaller value for higher communication quality, such as a smaller error rate, smaller noise power or interference power, or smaller propagation attenuation, is used to carry out network coordination in such a way that the range of resource allocation becomes greater as the product of the traffic and the quality coefficient becomes greater. By thus carrying out network coordination in consideration of communication quality, a large amount of resource reserved for parity signal can be allocated to a radio station that has low communication quality and therefore needs a large amount of resource reserved for parity signal. Also, by carrying out network coordination based on a statistical characteristic of communication quality such as an error rate with which a sudden change is less likely to happen, instead of an individual error with a large instantaneous change, the cost of control can be restrained to a low level.

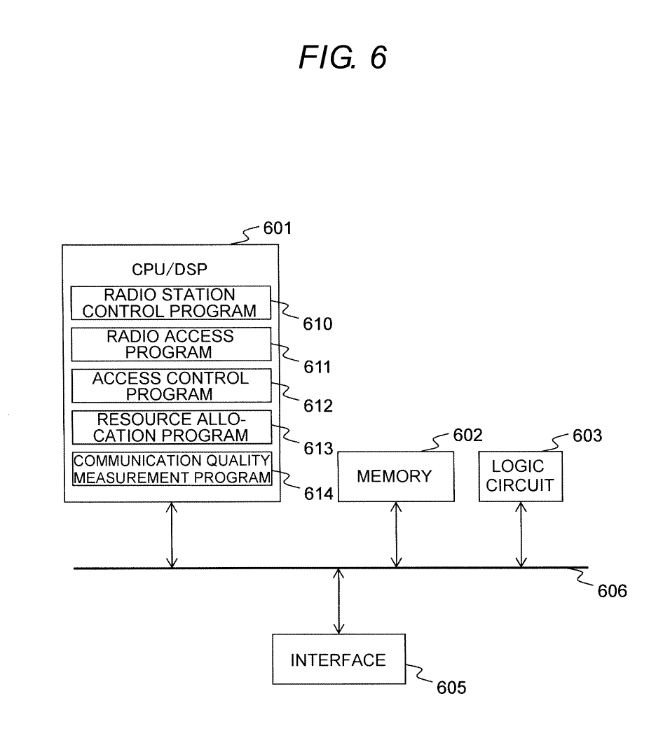

FIG. 6 is a block diagram schematically showing the hardware configuration of a radio station including a DSP and a CPU as principal components according to an embodiment of the invention.

The device configured as shown in FIG. 6 includes a CPU and DSP module 601, a memory 602, a logic circuit module 603, and an interface 605, which are connected to each other via a bus 606.

The processing by each functional block (for example, each block shown in FIG. 2) in each functional configuration of each device is carried out using one or both of a program in the CPU/DSP module 601 and an arithmetic circuit in the logic circuit module 603, and if necessary, using the memory 602. Also, information required by each functional block in each functional configuration, for example, operation parameters accumulated in the radio station control block 200, transmission and reception data accumulated in the transmit buffer block 221 and the receive buffer block 223, and measurement information accumulated in the communication quality measurement block 240 or the like, is held in the memory 602.

For example, the CPU/DSP module 601 may hold a radio station control program 610, a radio access program 611, an access control program 612, a resource allocation program 613, and a communication quality measurement program 614. The radio station control program 610, the access control program 612, the resource allocation program 613, and the communication quality measurement program 614 are executed by the CPU/DSP module 601 in order to execute the processing by the radio station control block 200, the access control block 220, the resource allocation block 230, and the communication quality measurement block 240, respectively. The radio access program 611 is executed by the CPU/DSP module 601 in order to execute the processing by the data transmitting block 211, the Ack information transmitting block 212, the data receiving block 213, and the Ack information receiving block 214 of the radio access block 210. Also, the above programs may be held in the memory 602 and executed by the CPU/DSP module 601.

FIG. 6 shows an example of the hardware configuration of a radio station with resource allocation function. A radio station without resource allocation function does not hold the resource allocation program 613.

The hardware configuration of the network coordinator 121, too, may be similar to the configuration shown in FIG. 6. However, the CPU/DSP module 601 or the memory 602 of the network coordinator 121 holds a network coordination program (not shown) instead of each program shown in FIG. 6 and the CPU/DSP module 601 executes this program, thus realizing the network coordination function (for example, the setting of the range of resource allocation).

If one of the radio stations (for example, the radio station 101) has the network coordination function, instead of the configuration where the radio communication system has the network coordinator 121, the CPU/DSP module 601 or the memory 602 of that radio station holds a network coordination program (not shown) in addition to each program shown in FIG. 6 and the CPU/DSP module 601 executes this program, thus realizing the network coordination function.

A part or the whole of the processing of each of the functional blocks may be executed by the logic circuit module 603, instead of being executed by the CPU/DSP module 601.

The interface 605 is equivalent to the interface block 250 in the functional configuration and carries out connection to other functions than the functions related to radio communication, for example, wired connection, a measuring sensor, and a user interface.

Each module and bus in FIG. 6 need not be single. For example, there may be plural CPU/DSP modules 601 and there may be plural buses 606. If there are plural buses 606, not all buses need to be connected to all the modules. For example, there may be a bus that connects only the memory 602 and the logic circuit module 603, as well as a bus that connects to all the modules.

If, for example, each of the signal processing arithmetic operation and the signal processing control in all the functions can be executed by the CPU/DSP module 601, the logic circuit module 603 may be omitted. Conversely, if, for example, each of the signal processing arithmetic operation and the signal processing control in all the functions can be executed by the logic circuit module 603, the CPU/DSP module 601 may be omitted.

The above embodiments are described, using an example in which the resource allocated by the resource allocation function of the radio stations is time. However, the invention can also be applied to allocation of any resource, for example, codes in CDMA (code division multiple access) or time and frequency or the like in OFDMA (orthogonal frequency division multiple access).

The division of functions described in the embodiments is only an example. Other configurations can be employed as long as equivalent functions as each embodiment of the radio communication system and the radio station as a whole can be realized. The above embodiments are described in detail in order to facilitate understanding of the invention, and the invention is not limited to a configuration including all the configuration components described above. Moreover, a part of the configuration of an embodiment may be replaced by the configuration of another embodiment, and the configuration of an embodiment may be added to the configuration of another embodiment. Also, addition, deletion, and replacement with another configuration may be made to a part of the configuration of each embodiment.

What is claimed is:

1. A radio communication system comprising plural radio stations, wherein
at least one of the plural radio stations has a communication resource allocation function,
the radio station with communication resource allocation function
allocates a part of an allocatable communication resource as one or more individual resources in which a source radio station and a destination radio station are individually set, and
allocates another part of the allocatable communication resource as one or more shared resources which are used in common by plural source radio stations or plural destination radio stations, and
each of the radio stations
encodes a transmission signal using a systematic code,
sends the transmission signal before being encoded, using the individual resource allocated to each of the radio stations, and
sends a parity portion of the encoded transmission signal, using the shared resource allocated to each of the radio stations.

2. The radio communication system according to claim 1, wherein the radio station with communication resource allocation function allocates the individual resource and the shared resource in such a way that the amount of the shared resource occupying the allocatable communication resource is smaller than the amount of the individual resource.

3. The radio communication system according to claim 1, further comprising
a network coordinator, and
plural radio stations with communication resource allocation function,
wherein the network coordinator sets a resource range that is a range in which the radio station with communication resource allocation function allocate, for each of the radio stations with communication resource allocation function, and sets the resource range in such a way that the resource range becomes greater as traffic of the radio station with the resource range set therefor becomes greater.

4. The radio communication system according to claim 1, further comprising
a network coordinator, and
plural radio stations with communication resource allocation function,
wherein the network coordinator sets a resource range that is a range in which the radio station with communication resource allocation function allocates, for each of the radio stations with communication resource allocation function, and sets the resource range in such a way that the resource range becomes greater as communication quality of the radio station with the resource range set therefor becomes lower.

5. The radio communication system according to claim 4, wherein the network coordinator uses an error rate of the radio station as the communication quality and handles the communication quality as being lower as the error rate becomes higher.

6. The radio communication system according to claim 4, wherein the network coordinator uses at least one of noise power and interference power in the radio station as the communication quality and handles the communication quality as being lower as at least one of the noise power and the interference power becomes higher.

7. A radio station included in a radio communication system,
the radio station comprising a communication resource allocation function which carries out allocation of a communication resource between radio stations included in the radio communication system,
wherein the communication resource allocation function allocates a part of an allocatable communication resource as one or more individual resources in which a source radio station and a destination radio station are individually set,
allocates another part of the allocatable communication resource as one or more shared resources which are used in common by plural source radio stations or plural destination radio stations,
encodes a transmission signal using a systematic code,
sends the transmission signal before being encoded, using the individual resource, and
sends a parity portion of the encoded transmission signal, using the shared resource.

8. The radio station according to claim 7, wherein the individual resource and the shared resource are allocated in such a way that the amount of the shared resource is smaller than the amount of the individual resource.
